(19) United States
(12) Patent Application Publication
(10) Pub. No.: US 2025/0141314 A1
(43) Pub. Date: May 1, 2025

(54) ELECTRIC AXIAL FLUX MACHINE, AN ELECTRIC AXLE DRIVE TRAIN

(71) Applicant: Schaeffler Technologies AG & Co. KG, Herzogenaurach (DE)

(72) Inventors: Sebastian Köpfler, Bräunlingen (DE); Dirk Reimnitz, Bühl (DE); Holger Witt, Bühl (DE)

(73) Assignee: Schaeffler Technologies AG & Co. KG, Herzogenaurach (DE)

(21) Appl. No.: 18/837,606

(22) PCT Filed: Jan. 31, 2023
(86) PCT No.: PCT/DE2023/100070

§ 371 Date: Aug. 12, 2024

(30) Foreign Application Priority Data
Feb. 14, 2022 (DE) 10 2022 103 389.9
Jun. 9, 2022 (DE) 10 2022 114 476.3

(51) Int. Cl. H02K 11/21; H02K 7/00; H02K 11/00

(52) U.S. Cl. CPC H02K 11/21; H02K 7/003; H02K 11/0094

(57) ABSTRACT

An electric axial flux machine, in particular for a drive train of a hybrid or fully electrically operated motor vehicle is disclosed. The axial flux machine includes a stator having a first annular disc-shaped stator body; and a rotor arranged axially at a distance from said stator. The axial flux machine also has a rotor position sensor which comprises a sensor target and by means of which the position of the rotor relative to the stator can be determined. The rotor position sensor with the sensor target is positioned radially inside the first annular disc-shaped stator body with at least one overlap region, that is axial in sections, with the first stator body inside the axial flux machine.

### CROSS-REFERENCE TO RELATED APPLICATIONS

This application is the U.S. National Phase of PCT Appln. No. PCT/DE2023/100070 filed Jan. 31, 2023, which claims priority to DE 10 2022 103 389.9 filed Feb. 14, 2022 and DE 10 2022 114 476.3 filed Jun. 9, 2022, the entire disclosures of which are incorporated by reference herein.

### TECHNICAL FIELD

The present disclosure relates to an electric axial flux machine, in particular for a drive train of a hybrid or fully electric motor vehicle, wherein the axial flux machine has a stator having a first annular disc-shaped stator body and a rotor axially spaced therefrom, and the axial flux machine further has a rotor position sensor having a sensor target, by means of which the position of the rotor relative to the stator can be determined. The disclosure further relates to an electric axle drive train.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, May 2011, pages 10-14 by Erik Schneider, Frank Fickl, Bernd Cebulski and Jens Liebold with the title: “Hochintegrativ und flexibel-Elektrische Antriebseinheit für E-Fahrzeuge” [Highly Integrative and Flexible-Electric Drive Unit for Electric Vehicles], which is probably the closest prior art. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

Increasingly, axial flux machines are also used in such e-axles. An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric vehicles described at the outset. In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

In electric motors, it is very important how the parts through which the magnetic field flows are positioned relative to each other. This concerns both the mechanical structure of the electric motor, through which the parts are held and precisely positioned, as well as the precise knowledge of the angular position of the rotating parts. An exact, rigid mechanical structure is important, since even small position deviations for the parts among one another can have a significant effect on the magnetic flux (e.g., due to altered air gaps). In addition, precise knowledge of the current position of the rotor is also crucial, because the constantly changing position of the magnets integrated into the rotating rotor (angular position) relative to the magnets integrated into the stator must always be known exactly when the motor is rotating to control the electric motor correctly. The changing angular position of the rotor must be known precisely at all times to determine the orientation of the rotor components (e.g., the rotor magnets, which are usually designed as permanent magnets) relative to the stator components (e.g., the stator magnets, which are usually designed as electromagnets) and to be able to adjust the control of the motor accordingly.

It is therefore important to integrate a rotor position sensor into the mechanical structure of the electric motor in such a way that the sensor can detect the relative position of the magnetically significant parts exactly, i.e., with the lowest possible tolerance influence. At the same time, however, the sensor must not negatively influence the mechanical structure of the electric motor due to its size and its installation conditions, so that a sufficiently robust and dimensionally accurate design of all parts and assemblies is possible, as is their precise alignment during assembly.

Especially in electric motors for vehicle applications, the rotor position sensor must be integrated into the structure of the motor as compactly and cost-effectively as possible.

In an axial flux motor, the magnetic fields acting between the disc-shaped rotor and stator assemblies, which are separated only by narrow air gaps, are mainly axially extending and can generate a torque that drives the rotor. The disc-shaped design of the rotors and stators allows air gaps to extend far outwards between these components, so that the magnetic fields can act on large diameters, which leads to efficient torque build-up. Due to its disc-shaped main components, the axial flux motor is particularly suitable for applications where a very short overall length of the electric motor is important and the relatively large motor diameter is still acceptable. When developing axial flux motors, it is therefore very sensible to strive for a design that is as short as possible so that the theoretical advantage of the axial flux motor relative to the radial flux motor is maintained and at the same time to ensure that the outer diameter of the motor is not larger than absolutely necessary.

The rotor position sensor should therefore be integrated into the axial flux motor in such a way that it does not significantly increase the motor dimensions either axially or radially. In addition, the rotor position sensor must be positioned so that it is in operative connection with both the rotating rotor and the stationary stator to be able to detect the angular position of the rotor relative to the stator.

### SUMMARY

It is therefore the object of the disclosure to provide an axial flux machine having a rotor position sensor with a design that is as axially and radially as compact as possible. It is also the object of the disclosure to realize a correspondingly compact electric axle drive train.

This object is achieved by an electric axial flux machine, in particular for a drive train of a hybrid or fully electric motor vehicle, wherein the axial flux machine has a stator with a first annular disc-shaped stator body and a rotor axially spaced therefrom, and the axial flux machine further has a rotor position sensor with a sensor target, by means of which the position of the rotor relative to the stator can be determined, wherein the rotor position sensor with the sensor target is positioned radially within the first annular disc-shaped stator body with at least one sectionally axial overlap region with the first stator body within the axial flux machine.

This has the advantage that an axially particularly short design of an axial flux machine can be realized. The particularly advantageous arrangement and design variants described in more detail below also enable a simple and functionally reliable connection of the sensor target with the rotor and the rotor position sensor with the stator and thus enable a particularly high measurement accuracy. Due to the sufficiently large distance to the motor components through which the magnetic fields that cause the motor torque flow, the rotor position sensor is protected radially inside the rotor shaft and/or a rotor bearing from high temperatures and/or strong magnetic or electrical fields.

In addition, the particularly advantageous arrangement and design variants described in more detail below enable the rotor position sensor to be accessible from the side or front even when the axial flux machine is completely assembled. This allows the rotor position sensor to be mounted very late in the assembly process of the axial flux machine, which reduces the risk of damage during motor assembly and also facilitates subsequent repair or replacement of the rotor position sensor.

The magnetic flux in an electric axial flux machine (AFM), such as an electric drive machine of a motor vehicle designed as an axial flux machine, is directed axially to a direction of rotation of the rotor of the axial flux machine in the air gap between the stator and the rotor.

Depending on the application, it can be advantageous to design an axial flux machine in an I-arrangement or an H-arrangement. In an I-arrangement, the rotor is arranged to be axially adjacent to a stator or between two stators. In an H-arrangement, two rotors are arranged on opposite axial sides of a stator. The axial flux machine according to the disclosure is preferably configured as an I-type.

In principle, it is also possible for a plurality of rotor-stator configurations to be arranged to be axially adjacent as an I-type and/or H-type. In this context, it would also be possible to arrange several I-type rotor-stator configurations adjacent to each other in the axial direction. In particular, it is also preferable that the rotor-stator configurations of the H-type and/or the I-type are each designed essentially identically, so that they can be assembled in a modular manner to form an overall configuration. Such rotor-stator configurations can in particular be arranged to be coaxial to one another and can be connected to a common rotor shaft or to multiple rotor shafts.

The stator of an electric axial flux machine preferably has a stator body with multiple stator windings arranged in the circumferential direction. The stator body can be designed to be in one piece or segmented, as seen in the circumferential direction. The stator body can be formed from a laminated stator core having multiple laminated electrical sheets. Alternatively, the stator body can also be formed from a compressed soft magnetic material, such as what is termed an SMC (soft magnetic compound) material.

The rotor of an electric axial flux machine can be designed at least in parts as a laminated rotor. A laminated rotor is designed to be layered in the axial direction. Alternatively, the rotor of an axial flux machine can also have a rotor carrier which is correspondingly equipped with magnetic sheets and/or SMC material and with magnetic elements designed as permanent magnets. Preferably, the rotor does not contain any other magnetically conductive materials besides the permanent magnets. In particular, the permanent magnets can also be accommodated in a rotor made entirely or partially from a plastic.

A rotor shaft is a rotatably mounted shaft of an electric machine to which the rotor or rotor body is coupled in a non-rotatable manner.

The electric axial flux machine can furthermore have a control unit. A control unit, as used in the present disclosure, serves in particular in open- and/or closed-loop electronic control of one or more technical systems of a motor vehicle.

A control unit has, in particular, a wired or wireless signal input for receiving in particular electrical signals, such as sensor signals, for example. Furthermore, a vehicle controller likewise preferably has a wired or wireless signal output for the transmission of, in particular, electrical signals.

Open-loop control operations and/or closed-loop control operations can be carried out within the control unit. It is very particularly preferred for the control unit to comprise hardware that is designed to run software. The control unit preferably comprises at least one electronic processor for executing program sequences defined in software.

The control unit can furthermore have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of control devices which are arranged in particular to be spatially separate from one another in the motor vehicle. Control devices are also referred to as electronic control units (ECU) or electronic control modules (ECM) and preferably have electronic microcontrollers for carrying out computing operations for processing data, particularly preferably using software. The control devices can preferably be interconnected with one another such that a wired and/or wireless data exchange between control devices is enabled. In particular, it is also possible to interconnect the control devices with one another via bus systems present in the motor vehicle, for example, such as a CAN bus or LIN bus.

Very particularly preferably, the control unit has at least one processor and at least one memory, which in particular contains a computer program code, the memory and the computer program code being configured with the processor to cause the control unit to execute the computer program code.

The control unit can particularly preferably comprise a power electronics unit for energizing the stator or rotor. A power electronics unit is preferably a combination of different components that control or regulate a current to the electric machine, preferably including the peripheral components required for this purpose, such as cooling elements or power supply units. In particular, the power electronics unit contains one or more power electronics components that are configured to control or regulate a current. These are particularly preferably one or more power switches, such as power transistors. The power electronics unit particularly preferably has more than two, particularly preferably three, phases or current paths which are separate from one another and each have at least one separate power electronics component. The power electronics unit is preferably designed to provide open- or closed-loop control of a power per phase with a peak power, preferably continuous power, of at least 1,000 W, preferably at least 10,000 W, particularly preferably at least 100000 W.

The electric axial flux machine is intended in particular for use within a drive train of a hybrid or fully electrically driven motor vehicle. In particular, the electric machine is dimensioned such that vehicle speeds of more than 50 km/h, preferably more than 80 km/h, and in particular more than 100 km/h can be achieved. The electric motor particularly preferably has an output of more than 50 KW, preferably more than 100 KW, and in particular more than 250 kW. Furthermore, it is preferred that the electric machine provides operating speeds greater than 5,000 rpm, particularly preferably greater than 10,000 rpm, very particularly preferably greater than 12,500 rpm. Most preferably, the electric machine has operating speeds between 5,000-15,000 rpm, most preferably between 7,500-13,000 rpm.

The electric axial flux machine can preferably also be installed in an electrically operated axle drive train. An electric axle drive train of a motor vehicle comprises an electric axial flux machine and a transmission, wherein the electric axial flux machine and the transmission form a structural unit. Provision can in particular be made for the electric axial flux machine and the transmission to be arranged in a common drive train housing. Alternatively, it would of course also be possible for the electric axial flux machine to have a motor housing and the transmission to have a transmission housing, in which case the structural unit can then be achieved by fixing the transmission in relation to the electric axial flux machine. This structural unit is sometimes also referred to as an e-axle.

The electric axial flux machine can in particular also be intended for use in a hybrid module. In a hybrid module, structural and functional elements of a hybridized drive train can be spatially and/or structurally combined and preconfigured such that a hybrid module can be integrated into a drive train of a motor vehicle in a particularly simple manner. In particular, an electric axial flux machine and a clutch system, in particular with a disconnect clutch for engaging the electric motor in and/or disengaging the electric motor from the drive train, can be present in a hybrid module.

The sensor housing has the function of fixing the active components of the rotor position sensor to each other. For this purpose, the sensor housing can also be designed in the shape of a plate. Preferably, however, the sensor housing is designed such that it partially or completely encloses the active components of the rotor position sensor. The sensor housing can be designed in one piece or multiple pieces. Most preferably, the sensor housing is pot-shaped with a plate-like closure element. Preferably, the sensor housing is also made of a plastic.

Advantageous embodiments of the disclosure are specified in the claims, description and figures. The features listed individually in the claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the rotor comprises, at least in sections, a rotor shaft designed as a hollow shaft, and the sensor target is arranged in the hollow shaft which enables an axially particularly compact design of the axial flux machine. In this context, it is also conceivable that the rotor shaft is also designed as a hollow shaft in sections, in that the rotor shaft has a concentric blind hole.

According to a further preferred development of the disclosure, it can also be provided that the rotor position sensor engages axially at least partially, preferably completely, in the hollow shaft, which also contributes to an axially particularly compact design of the axial flux machine.

Furthermore, according to a likewise advantageous embodiment of the disclosure, it can be provided that the rotor shaft is mounted relative to the first stator body via a first rolling bearing and relative to the second stator body via a second rolling bearing, wherein the rotor position sensor with the sensor target is arranged radially within the first rolling bearing, which contributes to a radially and axially compact design.

According to a further particularly preferred embodiment of the disclosure, it can be provided that the rotor position sensor and/or the sensor target have/has an axial overlap region with the first rolling bearing, which also enables an axially as well as radially particularly compact design of an axial flux machine.

Furthermore, the disclosure can also be further developed in such a way that the rotor position sensor has a substantially cylindrical sensor housing which is arranged radially at least in sections within the annular disc-shaped stator body and projects axially at least in sections into the first annular disc-shaped stator body. The advantage of this design is that the rotor position sensor can be provided preconfigured in the sensor housing, which noticeably simplifies its installation.

In a likewise preferred embodiment variant of the disclosure, it can also be provided that the axial flux machine is accommodated in a motor housing, wherein the motor housing has a housing section running in a radial plane to which the sensor housing is fastened. This enables a structurally particularly rigid connection to be achieved between the motor housing and thus also the stator, which results in a correspondingly good measurement accuracy of the rotor position sensor.

It can also be advantageous to further develop the disclosure in such a way that the rotor position sensor has at least one electrical line which extends radially outward over the housing section. The advantage of this is that the cables are easily accessible during installation. The rotor position sensor is preferably connected to a control unit of the axial flux machine via the cables.

The arrangement variants of an axial flux machine described here are not only applicable for electric axle drive trains. The solutions presented can also be used for axial flux machines that are arranged elsewhere in a motor vehicle, for example.

The object of the disclosure can also be achieved by an electric axle drive train comprising a first axial flux machine and a second axial flux machine.

This makes it possible for each vehicle wheel of a vehicle axle to be driven separately by an axial flux machine. Such axle drive train concepts are also called twin-axle or dual-drive.

Finally, the disclosure can also be advantageously designed such that the rotor position sensor of the first axial flux machine and the rotor position sensor of the second axial flux machine are located directly opposite each other in the electric axle drive train, whereby in particular an advantageous cable routing between the axial flux machines can be realized.

### BRIEF DESCRIPTION OF THE DRAWINGS

The disclosure is explained in more detail below with reference to figures without limiting the general concept of the disclosure.

In the drawings:

FIG. 1 shows a first embodiment of an axial flux machine in a first axial sectional view,

FIG. 2 shows a first embodiment of an axial flux machine in a first axial sectional view,

FIG. 3 shows two rotor position sensors arranged to be adjacent to each other in a perspective view,

FIG. 4 shows a second embodiment of an axial flux machine in an axial sectional view,

FIG. 5 shows an electric axle drive train of a motor vehicle with two axial flux machines in a schematic block diagram.

### DETAILED DESCRIPTION

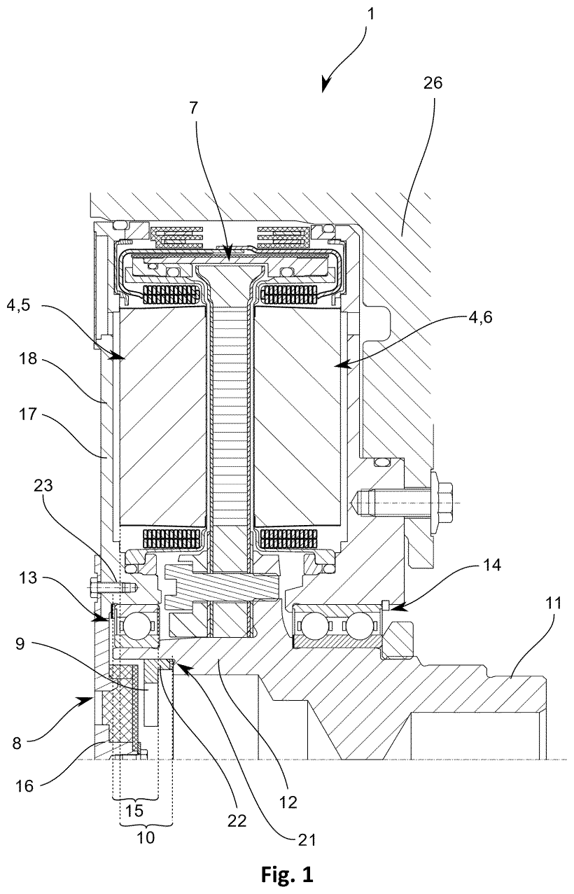

FIG. 1 shows an axial flux machine, which is useful for example for electric axle drive trains of motor vehicles. The electric axial flux machine 1 has a rotor 7 and a stator 4.

The stator 4 consists of two bodies 5, 6 connected to one another radially on the outside, each of which is connected to the rotor shaft 11 radially on the inside via a bearing point in a rotationally decoupled manner. The rotor 7 is fastened to the rotor shaft 11 and consists of a disc-shaped section extending radially outwards between the two stator bodies 5, 6. This corresponds to an axial flux machine 1 in I-arrangement. The air gaps through which the axial magnetic flux of the electric axial flux machine 1 runs are located between the two stator bodies 5, 6 and the rotor 7. In the axial flux machine 1 shown in half section in FIG. 1, the rotor 7 is equipped with permanent magnets and the stator 4 with electromagnets. The magnetic spring of the axial flux machine 1 can produce a torque that acts on the rotor 7 and is introduced therefrom into the rotor shaft 11. The rotor shaft 11 protrudes from the axial flux machine on one side in the axial direction and thus forms the transmission element through which the torque of the axial flux machine 1 can be transmitted to an adjacent unit. This adjacent unit can be, for example, a transmission, a differential, a shaft, or a wheel of the motor vehicle. The rolling bearings 13, 14 between the stator bodies 5, 6 and the rotor shaft 11 connect the rotor 7 to the stator 4 in a rotationally decoupled manner.

FIG. 1 therefore shows an electric axial flux machine 1, in particular for a drive train 2 of a hybrid or fully electric motor vehicle 3, wherein the axial flux machine 1 is configured in an I-design, in which the stator 4 has a first annular disc-shaped stator body 5 and a second annular disc-shaped stator body 6 axially spaced therefrom, and the rotor 7 is arranged to be axially between the first stator body 5 and the second stator body 6. The axial flux machine 1 further has a rotor position sensor 8 with a sensor target 9, by means of which the position of the rotor 7 relative to the stator 4 can be determined.

To detect the position of the rotor 7 relative to the stator 4, a rotor position sensor 8 is integrated in the axial flux machine 1. The rotor position sensor 8 is positioned with the sensor target 9 radially inside the first annular disc-shaped stator body 5 with at least one sectionally axial overlap region 10 with the first stator body 5 within the axial flux machine 1.

The rotor position sensor 8 is therefore located mostly radially inside the rotor shaft 11, which in this region is designed as a hollow shaft 12. The rotor position sensor 8 consists of an active and a passive part. The active part of the rotor position sensor 8, which is connected to the stator 4, contains the electrical or electronic components of the rotor position sensor 8 and is connected to a control unit of the axial flux machine 1. The passive part of the rotor position sensor 8 represents the sensor target 9, the angular position of which can be detected by the active part of the rotor position sensor 8.

In this embodiment shown, the sensor target 9 is formed by a disc provided with several recesses distributed around the circumference, which is connected to the hollow shaft 12. The active rotor position sensor 8 attached to the stator 4 detects the contour of the sensor target 9 which is interrupted on the circumference. Since the wing-like extensions of the passive sensor target 9 are matched in their number, in their circumferential extent and in their circumferential position to the magnets located in the rotor 7 (e.g., permanent magnets) and there is a fixed connection between the rotor magnets and the wing-like extensions of the passive sensor target 9 via the rotor shaft 11, which keeps the installation position relative to each other constant even during operation of the axial flux machine 1, the circumferential position of the rotor magnets relative to the stator 4 can be determined from the measurement signals of the active rotor position sensor 8, which reacts to the position of the extensions and recesses of the passive sensor target 9. Alternatively, the passive sensor target 9 can also be formed directly by the rotor shaft 11, for example by the shaft contour in front of the active rotor position sensor 8 having elevations and depressions that are arranged in a similar manner to the wing-like extensions just described above. Alternatively, the rotor position sensor 8 can also detect the position of more electrically or magnetically conductive regions and of poorly electrically or magnetically conductive regions, or detect the position of stronger magnetic regions and weaker magnetic regions.

The rotor position sensor 8, which contains the electronic components, is attached to the motor housing 17 of the first stator body 5 via a sensor housing 16. The sensor housing 16 is inserted into the central opening of the housing section 18 of the motor housing 17 extending in a radial plane and is screwed thereto. The sensor housing 16 closes the central opening of the housing section 18 and is located at a short distance axially in front of the annular front side of the axial end region of the rotor shaft 11 facing the rotor position sensor 8. Radially within the rotor shaft 11, which is formed at least in sections into the hollow shaft 12, the active rotor position sensor 8 is attached in an axially projecting manner to or in the sensor housing 16 and thus projects into the hollow shaft 12. The passive sensor target 9 is located axially in front of the active rotor position sensor 8 at a small axial distance. In this embodiment, the passive sensor target 9 is pressed into the hollow shaft 12 with its annular fastening region. Starting from the ring-shaped fastening region, the wing-like extensions protrude radially inwards. To be able to adjust the axial position of the passive sensor target 9 as easily as possible, an adjustment ring 22 is located between the ring-shaped fastening region of the passive sensor target 9 and the shaft shoulder 21, which serves as an axial stop during pressing in. By selecting an adjustment ring 22 with an appropriate axial thickness, it is easy to ensure that the passive sensor target 9 is pressed into the correct axial position.

The rotor 7 thus has a rotor shaft 11 designed as a hollow shaft 12 in which the sensor target 9 is arranged. The rotor position sensor 8 engages axially at least partially, preferably completely, into the hollow shaft 12. The axial flux machine 1 is accommodated in a motor housing 17, wherein the motor housing 17 has a housing section 18 running in a radial plane, to which the sensor housing 16 of the rotor position sensor 8 is fastened.

Alternatively, the sensor housing 16 can also be partially or completely formed as a single piece from the housing section 18 of the motor housing 17. The housing section 18 is then, for example, pulled radially inward so far that it can directly fix the active part of the rotor position sensor 8. A separate sensor housing 16 would then no longer be necessary.

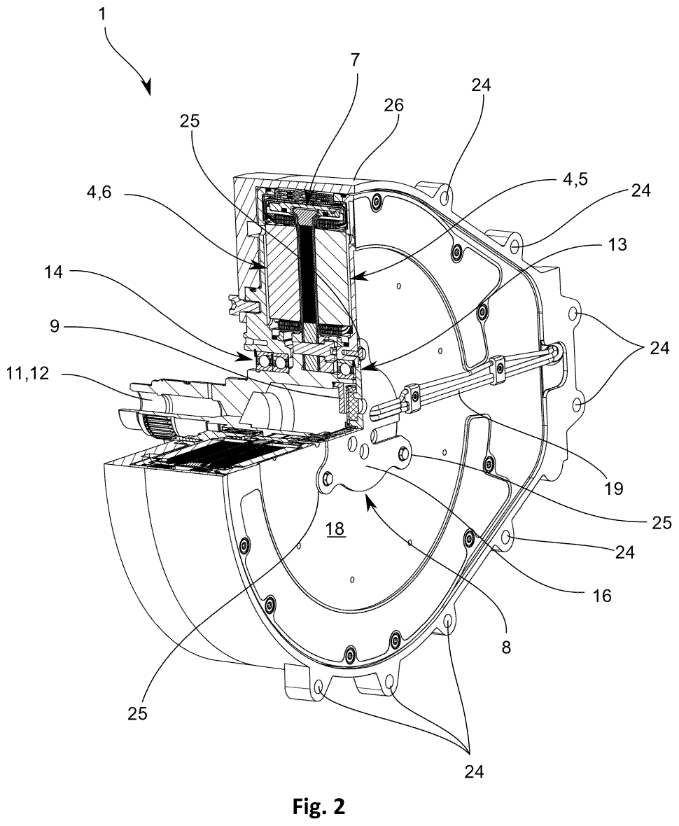

The embodiment shown in FIGS. 1-2 shows a particularly compact and space-saving arrangement of the rotor position sensor 8. The rotor position sensor 8 is located not only radially inside the rotor shaft 11, but also radially inside the rolling bearing 13 acting as a rotor bearing and radially inside the motor components through which the magnetic fields causing the motor torque flow, which in the case shown is in particular the first stator body 5. The rotor position sensor 8 is also located axially in a region in which are also arranged axial sections of the rotor shaft 11, the rolling bearing 13 and the motor components through which the magnetic fields causing the motor torque flow, namely the first stator body 5. Each of these features would already contribute to a compact motor design; in the combination shown here, the rotor position sensor 8 can be integrated into the axial flux machine 1 in a substantially space-neutral manner and contributes to the axial flux machine 1 being able to be designed to be very short axially.

The active rotor position sensor 8 is fastened to the housing section 18 of the motor housing 17, which is designed as a front side wall, in that the housing section 18 is axially thickened radially within the motor components through which the magnetic fields causing the motor torque flow, and this thickening has the axial threaded holes 23 for fastening the sensor housing 16 and the bearing seat for the outer ring of the rolling bearing 13.

Radially within the thickening, the housing section 18 merges into a short web pointing radially inwards, which serves axially as a contact surface for the rolling bearing 13 and has a centering seat radially inward for the sensor housing 16 of the rotor position sensor 8. Adjustment rings, not shown, between the housing section 18 and the rolling bearing 13 can also be useful at this point. A cylindrical outer surface of the sensor housing 16 is inserted into this centering seat. In addition, adjacent to the centering seat, a part of the sensor housing 16 projects radially outward past the housing section 18 of the motor housing 17 and is screwed there to the housing section 18. In the embodiment shown in FIGS. 1-2, this region of the sensor housing 16 is formed by three fastening tabs 25 distributed around the circumference, which can be clearly seen in FIG. 2. Between the three fastening tabs 25 there is space for the electrical lines 19 formed as cables, which connect the active part of the rotor position sensor 8 with the control unit of the axial flux machine 1, not shown. In addition, the space can also be used to accommodate other parts or components that must be arranged in the immediate vicinity of the axial flux machine 1.

Radially within the centering seat, the sensor housing 16 extends axially inwardly in front of the rolling bearing 13 and axially in front of the end of the rotor shaft 11, which forms the bearing seat for the inner bearing ring of the rolling bearing 13. The active part of the rotor position sensor 8 is then connected to the sensor housing 16 within the shaft end, which is designed as a hollow shaft 12 at least in the region of the rotor position sensor 8. The electronic components of the active rotor position sensor 8 are attached to or in the sensor housing 16.

FIG. 1 shows the axial flux machine 1 installed in a drive train housing 26. This motor arrangement is intended for an electric axle drive train 20 of a motor vehicle 3. Where the rotor shaft 11 protrudes axially from the axial flux machine 1 is connected a torque transmission element, for example a gear or a shaft, which transmits the torque of the axial flux machine 1 to one or more wheels of the vehicle 3. On the other side of the axial flux machine 1, on which the rotor position sensor 8 already shown in FIG. 1 can be seen, the drive train housing 26 is open. In particular, an essentially identical axial flux machine 1 can be attached to this side, also with a downstream torque transmission element, which also drives one or more wheels of the motor vehicle 3. The two axial flux machines 1 are connected to each other by screwing the front sides of the drive train housings 26 together. The screw holes 24 required for this purpose can be seen in FIG. 2 on the outer edge of the drive train housing 26.

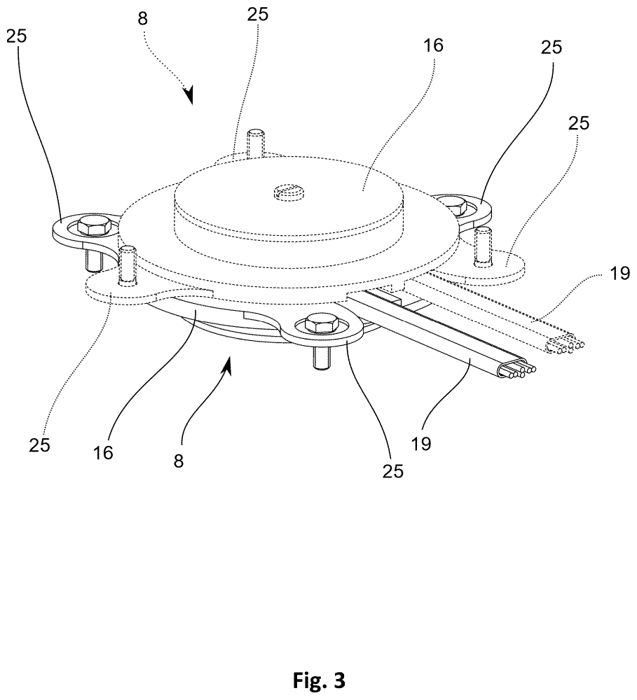

To enable the two axial flux machines 1 to be positioned axially very close to one another and thus to achieve a very compact design for the corresponding electric axle drive train 20, the rotor position sensor 8, its fastening elements, and its electrical lines 19 must not determine the axial installation space. FIGS. 2 and 3 show how an axially very compact design of the rotor position sensor 8 is possible, which also minimizes the axial space requirement of the sensor fastening elements and the electrical lines 19.

FIG. 2 shows that in this embodiment, three cables as electrical lines 19 lead radially outwards from the rotor position sensor 8 on the front side of the motor housing 17 and are then led out of the drive train housing 26 in the flange region of the drive train housing 26 through an oblique bore or a cable gland. To save axial space, several thin cables are arranged to be adjacent to each other. This requires less axial space than a cable with a round cross-section that contains all the required wires.

FIG. 3 alternatively shows an electrical line 19 designed as a cable with a flat cross-section, for example a flat cable or ribbon cable. In order for the cables to be able to be guided radially outwards along the housing section 18, the cables must of course rest on the housing section 18, just as the fastening tabs 25 of the sensor housing 16 must rest axially on the housing section 18 designed as a side wall to be able to be screwed axially to the side wall. To save axial installation space, the fastening tabs 25 and the lines 19 can only be arranged to be adjacent to each other and not one above the other, wherein adjacent to each other and one above the other refer to a viewing direction along the axis of rotation of the rotor 7, frontally to the front side of the motor housing 17. In addition, the lines 19 and fastening tabs 25 must be arranged in such a way that this requirement can still be met even if the second axial flux machine 1 is mounted in front of the first axial flux machine 1 rotated by 180° about the mirror axis.

The requirement that the fastening tabs 25 and the lines 19 can only be arranged to be adjacent to each other and not one above the other then refers to all fastening tabs 25 and all lines 19 of the two rotor position sensors 8 installed in the corresponding axle drive train 20.

Openings are provided in the respective sensor housing 16 through which the lines 19 can be laid from the active part of the rotor position sensor 8 to the rear of the sensor housing 16 or the housing section 18. And starting from the opening through which the lines 19 are pulled, recesses that partially reduce the material thickness of the sensor housing 16 to the axial level of the front side of the housing section 18 extend to the edge of the sensor housing 16. In addition, the fastening tabs 25 are arranged on the circumference offset from the openings for the cables 19. Through these openings and adjacent recesses on the rear side of the sensor housing 16, the lines can also be guided radially outward in the region of the sensor housing 16 at the same axial level that they also occupy radially further outward on the housing section 18.

Since the front side of the drive train housing 26, i.e., the surface of the drive train housing 26 with which the two housing halves touch when two axial flux machines 1 are arranged to be adjacent to each other, is not round, but as can be seen in FIG. 2, there is a point at which the housing contour is drawn radially further outwards than on the remaining circular circumferential region, the two axial flux machines 1 can only be screwed together in a single position. The geometry of the two drive train housings 26 are rotated by 180° with respect to each other. This rotation or mirror axis of the geometry then lies in the plane of the two touching housing front sides, orthogonally intersects the rotation axis of the rotors 7, and runs through the center of the housing region that is drawn radially further outwards. If this rotational axis or mirror axis were drawn into FIG. 2, the rotation or mirror axis would run parallel to the lines 19, offset slightly downwards, so that the rotation or mirror axis would intersect the rotation axis of the rotor 7. Since the lines 19 do not lie on the rotation or mirror axis, but are offset therefrom and do not intersect the rotation or mirror axis, the lines 19 of the two adjacent axial flux machines 1 do not meet.

It can be seen in FIG. 2 that below the lines 19 and also below the rotation or mirror axis there is a region in which no raised elements are arranged on the housing section 18. There, a further recess is also provided in the sensor housing 16 of the rotor position sensor 8 and the recess for the passage of the lines 19 is widened on one side radially outside on the drive train housing 26. All these measures ensure that space is provided for the lines 19 of the adjacent axial flux machine 1 and that the two axial flux machines 1 can be arranged axially very close to one another without them accidentally touching or even damaging one another.

FIG. 2 also shows that in the sensor housing 16 of the rotor position sensor 8 the recesses for the lines 19 are not placed in the middle between two fastening tabs 25. Or in other words, the fastening tabs 25 were arranged asymmetrically to the lines 19 and the rotation or mirror axis. This ensures that the fastening tabs 25 and fastening screws of the two adjacent axial flux machines 1 do not come into contact with other fastening tabs 25, fastening screws, cables 19, or cable clamps.

FIG. 3 shows two rotor position sensors 8 in the arrangement in which they are located relative to each other when they are mounted on two adjacent axial flux machines 1 of an axle drive train 20. To better distinguish between the two rotor position sensors 8, the upper rotor position sensor 8 is shown in dashed lines. The lower rotor position sensor 8 is shown with solid lines. It can be clearly seen in FIG. 3 that the fastening tabs 25 of the two rotor position sensors 8 are arranged to be offset from one another on the circumference and do not touch one another. The example shows three fastening tabs 25 per rotor position sensor 8. With the principle of fastening tabs 25 arranged asymmetrically to the rotational axis or mirror axis, even more fastening points per rotor position sensor 8 can be realized (for example six) without causing unwanted collisions. In this embodiment, the rotation or mirror axis of the sensor geometries is located parallel to the lines 19 directly in the middle between the two corresponding cable harnesses.

As an alternative embodiment, FIG. 3 does not show several individual lines 19 per rotor position sensor 8, but rather a cable with a flat cross-section (flat cable, ribbon cable). In addition, in both rotor position sensors 8, the respective lines 19 are each arranged to be directly adjacent to a fastening tab 25 of the respective rotor position sensor 8. This makes it possible to use the fastening tab 25 also for fastening the cables 19 and reduces the number of places on the circumference of the sensor arrangement where geometric elements of the adjacent rotor position sensors 8 must interlock. This also has installation space advantages, since geometric elements belonging to the same rotor position sensor 8 can be moved closer together on the circumference than geometric elements of neighboring assemblies, since larger distances must be maintained between the geometric elements of neighboring assemblies for the longer tolerance chains and for the larger required assembly clearance.

In FIG. 3 it can also be seen that a recess is arranged in the sensor housing 16 of the other rotor position sensor 8 in front of each line 19 of one rotor position sensor 8. It is advisable to make the recess in the sensor housing 16, which is intended for the lines 19 of the other rotor position sensor 8, wider than the recess for the lines 19 of the rotor position sensor 8 itself. As a result, the cables 19 are well guided in the recess of their own rotor position sensor 8 and fit into the recesses of the neighboring sensors even in the event of position deviations between the two rotor position sensors 8, which cannot be completely avoided.

FIG. 3 shows two rotor position sensors 8 arranged to be adjacent to one another in a perspective view. The two rotor position sensors 8, which can be distinguished in FIG. 3 by the use of a solid line and a dashed line, can have direct contact or can be arranged at a small distance from one another.

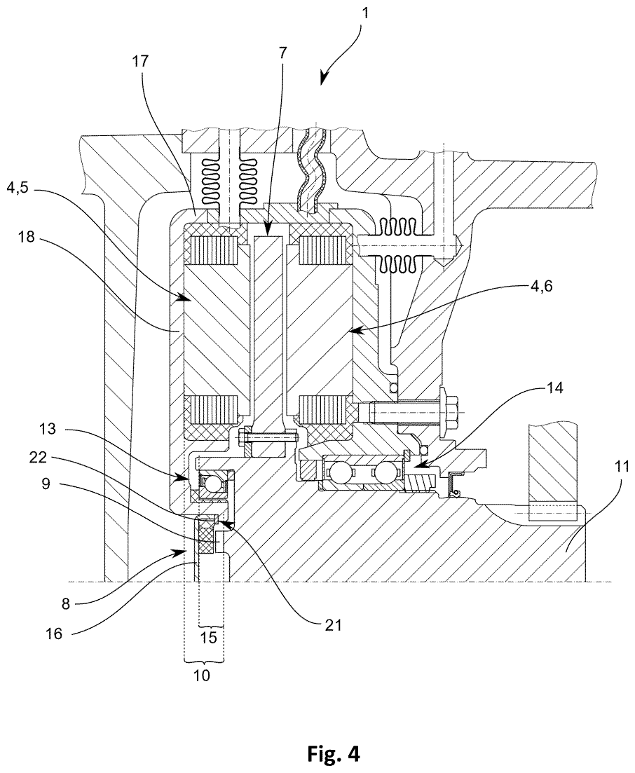

FIG. 4 shows a further embodiment of an axial flux machine 1 with a rotor position sensor 8 arranged radially inside the rotor shaft 11. In the embodiment shown in FIG. 4, the housing section 18 of the stator 4 is pulled axially past the first rolling bearing 13 to the radial inside and supports the rolling bearing 13 on the bearing inner ring. In addition, the inner region of the housing section 18, which is shaped into a bearing seat, serves as a carrier for the rotor position sensor 8. In this embodiment, the housing section 18 takes over almost all the tasks that the sensor housing 16 had in the previously described embodiment. The cover-like sensor housing 16 of the active rotor position sensor 8 closes the inner opening in the housing section 18 designed as a stator side wall and protects the rotor position sensor 8 from contamination.

Alternatively, the housing section 18 can also be pulled completely inwards. If the sensor housing 16, as in the first embodiment of FIGS. 1-2, is designed to be robust enough and is connected to the housing section 18, the sensor housing 16 can also be used to support the first rolling bearing 13. The sensor housing 16 can then form the entire bearing seat or, if the sensor housing 16 replaces, for example, the inwardly facing web on the housing section 18 of the first embodiment, can serve as an axial stop for the first rolling bearing 13.

FIG. 4 further shows that the active rotor position sensor 8 in this embodiment is pressed into the cylindrical inner part of the housing section 18. To be able to adjust the axial position of the active rotor position sensor 8 as easily as possible, an adjustment ring 22 is located between the sensor housing 16 of the active rotor position sensor 8 and the shoulder 21 of the housing section 18, which serves as an axial stop during pressing in. By selecting an adjustment ring 22 with a suitable axial thickness, it is easy to ensure that the active rotor position sensor 8 is pressed into the correct axial position. This principle of adjusting the axial distance between the active and passive sensor parts by means of an adjusting element with variable thickness on the active rotor position sensor 8 can also be transferred to the first embodiment. There, an adjusting ring or an adjusting plate, the axial thickness of which is selected as required, can be arranged between the housing section 18 and the sensor housing 16.

In the embodiment of FIG. 4, the passive part of the sensor, i.e., the sensor target 9, is formed from or with the rotor shaft 11. A circumferentially arranged sequence of elevations and depressions is arranged on the front side of the rotor shaft 11 and is in a fixed relationship to the position of the rotor magnets.

The embodiments of FIGS. 1-4 have in common that the rotor shaft 11 is mounted relative to the first stator body 5 via a first rolling bearing 13 and relative to the second stator body 6 via a second rolling bearing 14, wherein the rotor position sensor 8 with the sensor target 9 is arranged radially inside the first rolling bearing 13. The rotor position sensor 8 and/or the sensor target 9 have/has an axial overlap region 15 with the first rolling bearing 13, which also contributes to an axially compact configuration of an axial flux machine 1. The rotor position sensor 8 has a substantially cylindrical sensor housing 16, which is arranged radially at least in sections within the annular disc-shaped stator body 5 and projects axially at least in sections into the first annular disc-shaped stator body 5.

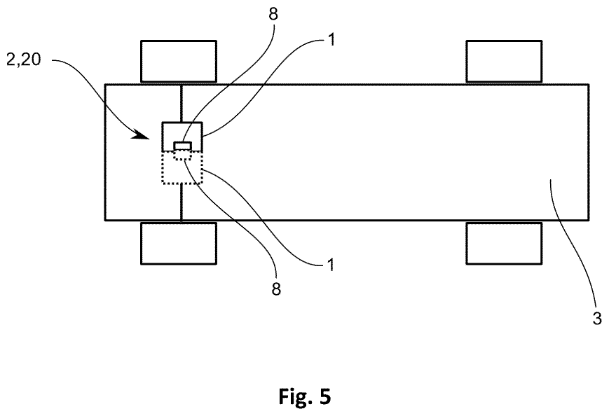

FIG. 5 shows an electric axle drive train 20 comprising a first axial flux machine 1 driving a first vehicle wheel and a second axial flux machine 1 driving a second vehicle wheel, wherein the axial flux machines 1 are essentially structurally identical. It can be clearly seen that the rotor position sensor 8 of the first axial flux machine 1 and the rotor position sensor 8 of the second axial flux machine 1 are located directly opposite each other in the electric axle drive train 20.

The terms “radial,” “axial,” “tangential,” and “circumferential direction” used in this application always refer to the rotational axis R of the axial flux machine 1. The terms “left,” “right,” “above,” “below,” “over”, and “under” are used here only to clarify which regions of the illustrations are currently being described in the text. The later embodiment of the disclosure can also be arranged differently. The disclosure is further not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Axial flux machine
2 Drive train
3 Motor vehicle
4 Stator
5 Stator body
6 Stator body
7 Rotor
8 Rotor position sensor
9 Sensor target
10 Coverage region
11 Rotor shaft
12 Hollow shaft
13 Rolling bearing
14 Rolling bearing
15 Coverage region
16 Sensor housing
17 Motor housing
18 Housing section
19 Line
20 Axle drive train
21 Shoulder
22 Adjustment ring
23 Threaded hole
24 Screw holes
25 Fastening tabs
26 Drive train housing

1. An electric axial flux machine comprising:
a stator with a first annular disc-shaped stator body,
a rotor axially spaced therefrom, and
a rotor position sensor with a sensor target, by means of which a position of the rotor relative to the stator can be determined,
wherein the rotor position sensor with the sensor target is positioned radially inside the first annular disc-shaped stator body with at least one sectionally axial overlap region with the first stator body within the axial flux machine.

2. The axial flux machine according to claim 1, wherein:
the rotor comprises a rotor shaft which is designed at least in sections as a hollow shaft and the sensor target is arranged in the hollow shaft.

3. The axial flux machine according to claim 2, wherein:
the rotor position sensor engages axially at least partially, preferably completely, in the hollow shaft.

4. The axial flux machine according to claim 2, wherein:
the rotor shaft relative to the first stator body via a first rolling bearing, wherein the rotor position sensor with the sensor target is arranged radially inside the first rolling bearing.

5. The axial flux machine according to claim 4, wherein:
the rotor position sensor and/or the sensor target have/has an axial overlap region with the first rolling bearing.

6. The axial flux machine according to claim 1, wherein:
the rotor position sensor has a substantially cylindrical sensor housing which is arranged radially at least in sections within the annular disc-shaped stator body and projects axially at least in sections into the first annular disc-shaped stator body.

7. The axial flux machine according to claim 6, wherein:
the axial flux machine is accommodated in a motor housing, wherein the motor housing has a housing section extending in a radial plane, to which the sensor housing is fastened.

8. The axial flux machine according to claim 7, wherein:
the rotor position sensor has at least one electrical line which extends radially outward over the housing section.

9. An electric axle drive train comprising a first axial flux machine according to claim 1 and a second axial flux machine according to claim 1.

10. The electric axle drive train according to claim 9, wherein:
the rotor position sensor of the first axial flux machine and the rotor position sensor of the second axial flux machine are located directly opposite each other in the electric axle drive train.
